(19) United States
(12) Patent Application Publication
(10) Pub. No.: US 2006/0015389 A1
(43) Pub. Date: Jan. 19, 2006

(54) Method and apparatus for real time monitoring of business services

(76) Inventor: Michael Perham, Austin, TX (US)

Correspondence Address: Rick B. Yeager, 10805 Mellow Lane, Austin, TX, 78759, US

(21) Appl. No.: 10/999,281

(22) Filed: Nov. 30, 2004

Related U.S. Application Data
(60) Provisional application No. 60/587,472, filed on Jul. 13, 2004.

(51) Int. Cl. G06Q 99/00

(52) U.S. Cl. 705/9; 705/1

(57) ABSTRACT

An API framework module is created that enables monitoring of business services and updating the monitoring of business services. The API framework module is used to create a monitoring utility to monitor business services and produce graphic representations of that monitoring. The API framework module is transferred to a business service and incorporated into the business service to enable the monitoring utility to collect required data. Subsequently the monitoring utility automatically queries the business service for monitoring, and the business service employs the API framework module to display at the monitoring utility the categories that can be monitored for the business service. An operator associated with the monitoring utility chooses the categories to be monitored and initiates the monitoring. The business service then sends graphic representations of the required monitored information to the monitoring utility for display there, with updates at specified intervals.

### CROSS-REFERENCE TO RELATED APPLICATIONS

This application claims the benefit of PPA Ser. No. 60/49587,472, filed Jul. 13, 2004 by the present inventor.

### FIELD OF THE INVENTION

This innovation relates to business services, and, more particularly, to methods that monitor the activities of business services and display graphic representations of the monitoring.

### BACKGROUND OF THE INVENTION

Business Services

Modern companies frequently employ business services, which are business-enterprise computer applications that can be used singly or collectively to accomplish a wide range of intended purposes, such as determining health-care patients' eligibility for benefits and submitting health-care claims. For example, business services designed for insurance companies help them rapidly automate their business processes, eliminating paper and manual touches and saving them tens of millions of dollars annually. Business services are typically deployed on one or more application-based servers, which are computers on networks that mange the networks. Often severs are deployed on a company-internal local network.

Business-Service Applications

Business-service applications are computer applications that use business services singly or collectively to accomplish intended purposes.

A business-service application typically consists of one or more business services, which may in turn employ one or more Web services and Web portal pages.

FIG. 1 shows an example of how multiple chained business services are might be used as part of a business-service application for the filing and payment of medical insurance claims. Chained business services are connected business services that may reside on different servers. In this example, a business employs a server 100 running a Web portal page 200 and a business-service application 240.

A Web portal page 200 is a Web-site interface that a person can reach over the Internet. Web-site interfaces are computer-programmed modules that allow end-users to select variables and parameters from easy-to-use visual displays or to type in this input, save the information through selecting a save option, and have their selections automatically applied by computer subsequently, without those users having to program the information manually.

To continue the example, an attendant at a clinic server 150 can use the Internet, through a wired or wireless link 144, a telephone network 130, and another wired or wireless link 142, to reach the portal Web page 200 on business server 100. The attendant can then use the portal Web page 200 to fill out a claim file form 220 for one of the clinic's patients and submit it for processing and payment through business service application 1 240.

Other means for submitting claims also exist. For example, an attendant at a clinic server 150 might use link 144, network 130, and link 142 for a machine-to-machine transmission of a claim file directly to business service application 1 240. Many kinds of wired and unwired links and networks could used for this machine-to-machine transmission, such as the Internet, a private LAN (Local Area Network), a wireless network, a TCP/IP (Transmission Control Protocol/Internet Protocol) network, or other communications system.

In the connected system of FIG. 1, business service application 1 240 receives a claim file through business service 1 242, which relays the data over a wired or wireless link 302, a network 2 300, which is a wired or wireless local network, and a wired or wireless link 304 to server 2 182. If necessary, business service 2 244 transforms the format of the claim file to a format that business-service application 1 240 can use for its full operations. For example, a claim file might have been sent in NSF (National Standard Format) format, but business-service application 1 240 might require HIPAA (Health Insurance Portability and Accountability Act) format.

After the claim file is transformed to the correct message format, business service 2 244 relays the data back over link 304, network 2 300, and a wired or wireless link 306 to server 3 184 and business service 3 246, which is used to validate the claim file.

In turn, business service 3 246 relays the data back over link 306, network 2 300, and a wired or wireless link 308 to server 4 186 and business service 4 248, used to correct errors in the claims file, either automatically or through further communications with the clinic that submitted the claim.

After any errors are corrected, business service 4 248 sends the data back over link 308, network 2 300, and a wired or wireless link 310 to server 5 188 and business service 5 250, which is used to send the claim file to the payer. Business service 5 250 sends the claim file back over link 310, network 2 300, link 302, link 142, network 1 130, and a wired or wireless link 148 to an insurance company server 170 for payment to the clinic.

To operate efficiently, businesses that run business service applications frequently need to monitor activities associated with their business services. Continuing with the example in FIG. 1, for example, the business that operates business service application 1 240 may need to know how frequently claims are being submitted to business service 1 242 in a given time period and how many of those claims require correction before they can be paid.

Furthermore, for ease of use businesses need to be able to read the results of monitoring in graphic presentations on computer screens or printouts. And for still greater accuracy and efficiency businesses need to have the monitoring and graphic representations updated periodically.

For these reasons, methods are needed that can monitor the activities of business services and automatically display graphic representations of the monitoring, updating them periodically.

Prior Techniques

To monitor the activities of business services, employees typically compile statistics by writing custom-designed query programs ad hoc for the databases associated with business services. After compiling these statistics, the employees then write reports on the results, often manually creating graphic representations of the data such as bar charts or line charts.

However, custom programming is time-consuming and requires special and expensive programming skill, which makes it expensive.

Therefore there is a need for a method and apparatus that provides a more automatic method for monitoring the activities of business services and displaying graphic representations of the monitoring and updating them periodically.

### BRIEF SUMMARY OF THE INVENTION

These and other needs are addressed by the present invention. The following explanation describes the present invention by way of example and not by way of limitation.

It is an aspect of the present invention to provide an automatic method for monitoring business services in a business service application and displaying graphic representations of the monitoring.

It is another aspect of the present invention to provide an API (application program interface) framework module that enables monitoring of business services.

It is another aspect of the present invention to provide a monitoring utility that conducts the monitoring of business services and generates graphic representations of that monitoring.

It is still another aspect of the present invention to provide a feature on the API framework module that periodically updates the monitoring of business services and the graphic representations of that monitoring.

These and other aspects, features, and advantages are achieved according to the method and apparatus of the present invention. In accordance with the present invention, an API framework module is created that enables monitoring of business services and updating the monitoring of business services. The API framework module is used to create a monitoring utility to monitor business services and produce graphic representations of that monitoring. The API framework module is transferred to a business service and incorporated into the business service to enable the monitoring utility to collect required data. Subsequently the monitoring utility automatically queries the business service for monitoring, and the business service employs the API framework module to display at the monitoring utility the categories that can be monitored for the business service. An operator associated with the monitoring utility chooses the categories to be monitored and initiates the monitoring. The business service then sends graphic representations of the required monitored information to the monitoring utility for display there, with updates at specified intervals.

### BRIEF DESCRIPTION OF THE DRAWINGS

The following embodiment of the present invention is described by way of example only, with reference to the accompanying drawings, in which:

FIG. 1 is a block diagram showing an example of loosely connected business services chained together through a business service application for filing patient claims;

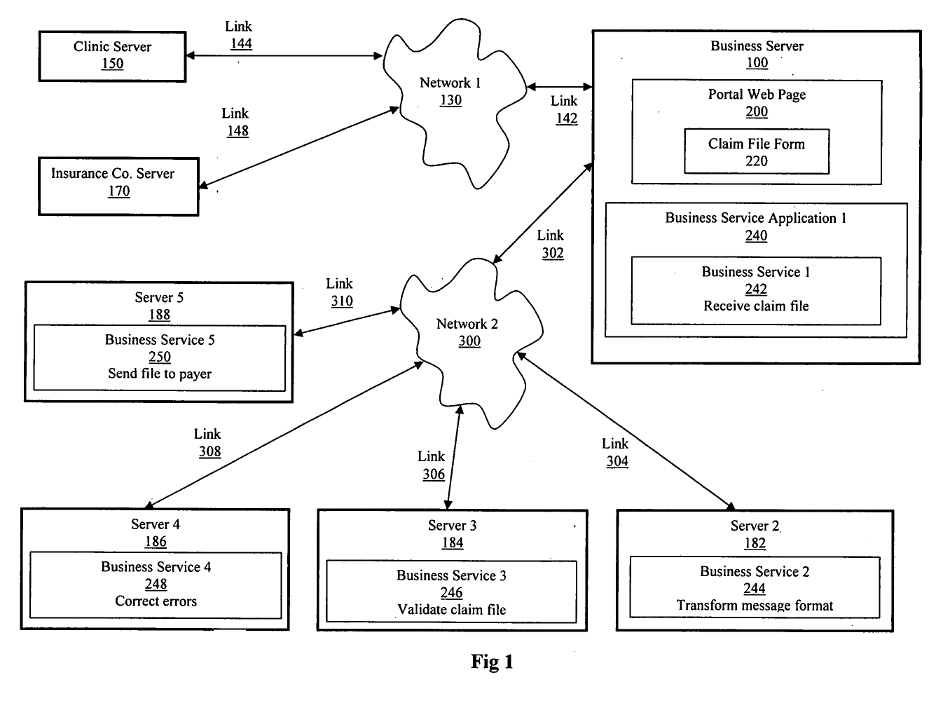

FIG. 2 is a block diagram showing an operating environment in which embodiments of the present invention may be employed;

FIG. 3 is a top-level flow chart that illustrates an automatic process for monitoring business services;

FIG. 4 is block diagram that illustrates an example of a screen display with useful categories that can be created through an API framework module;

FIG. 5 is block diagram that illustrates an example of a screen display with useful text and graphic elements that can be created through an API framework module;

FIG. 6 is block diagram that illustrates an example of useful metadata that might be made available through an API framework module;

FIG. 7 is a flow chart that illustrates the process of setting up a business service for monitoring;

FIG. 8 is a flow chart that illustrates the process of conducting monitoring;

FIG. 9 is a block diagram that illustrates a typical computer system, representing a server on which embodiments of the present invention can be implemented.

### DETAILED DESCRIPTION

The following description explains a method and apparatus to automatically monitor business services. The details of this explanation are offered to illustrate the present invention clearly. However, it will be apparent to those skilled in the art that the concepts of present invention are not limited to these specific details. Commonly known elements are also shown in block diagrams for clarity, as examples and not as limitations of the present invention.

Operating Environment

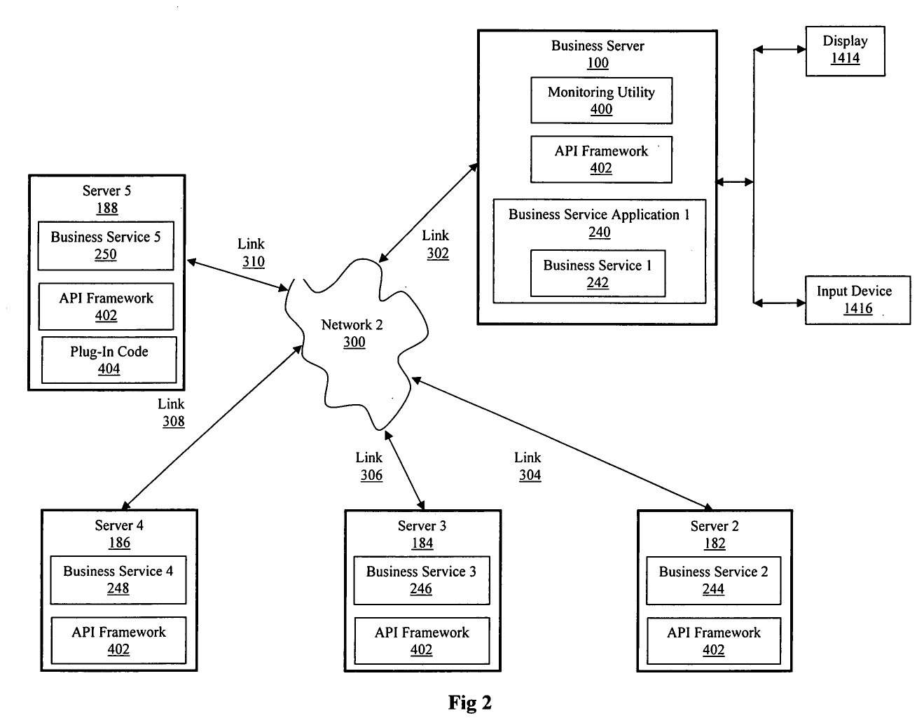

An embodiment of an operating environment of the present invention is shown in FIG. 2. A party employs a server 100 to run a business service application 240, which uses one or more business services, for example 242, 244, 246, 248, and 250 located on one or more servers, for example 100, 182, 184, 186, and 188. A server may be a personal computer or larger computerized system.

The business services 242, 244, 246, 248, and 250 communicate through a wired or wireless local network 300 and wired or wireless links 302, 304, 306, 308, and 310. The network 300 may be use a wired or wireless technology, for example a private LAN (Local Area Network) or other communications system, and may comprise multiple elements such as gateways, routers, and switches. The links 302, 304, 306, 308, and 310 are compatible with the technology used for network 300.

Attached to server 100, a display 141, for example a computer screen, and an input device 1416, for example a keyboard, permit one or more programmers to create software programs and communicate with remote servers.

Monitoring Process—Overview

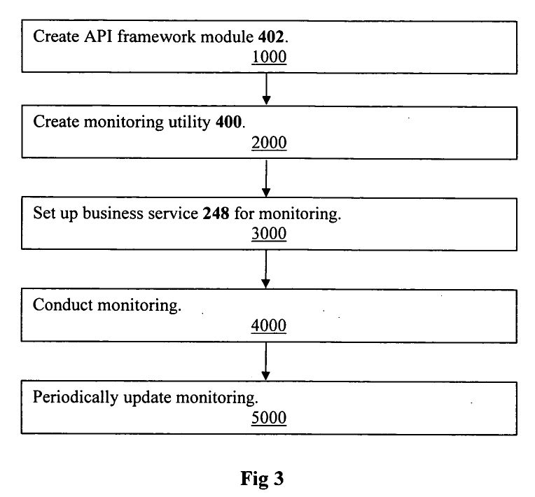

FIG. 3 is top-level flow chart that illustrates an automatic process for monitoring business services, through the operating environment shown in FIG. 2. It will be useful to explain the steps in this process briefly from a high level and then to expand elements of this explanation in detail.

Step 1000 in FIG. 3. Create API framework module 402.

A programmer creates an API framework module 402, shown in FIG. 2.

Step 2000 in FIG. 3. Create monitoring utility 400.

Using the API framework module 402, shown in FIG. 2, a programmer creates a monitoring utility 400.

Step 3000 in FIG. 3. Set up business service 248 for monitoring.

A business service 248, shown in FIG. 2, is set up for monitoring.

Step 4000 in FIG. 3. Conduct monitoring.

The monitoring utility 400, shown in FIG. 2, conducts monitoring.

Step 5000 in FIG. 3. Periodically update monitoring.

The business service 248, shown in FIG. 2, periodically updates the monitored information.

Creating the API Framework Module

The first step 1000, shown in FIG. 3, in setting up an automatic monitoring system is for a programmer to create an API framework module 402, shown in FIG. 2. The API framework module 402 provides a framework for each business service, such as business service 248, in a business service application 240, to respond to monitoring queries according to parameters set up for the business service 248. The parameters comprise useful categories of information to be monitored and metadata for the presentation of that information, which programmers can incorporate into the business service 248.

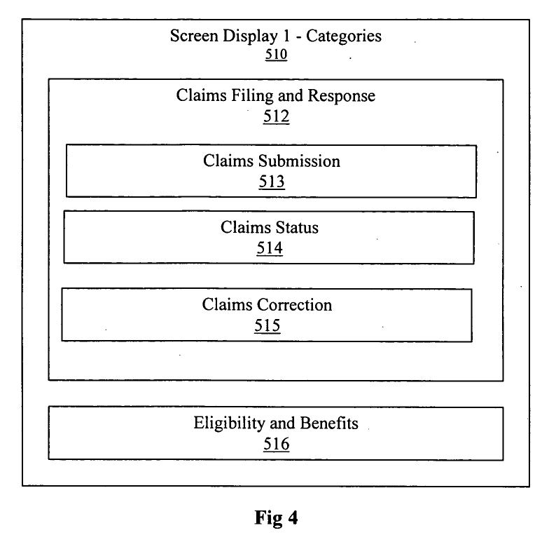

FIG. 4 is block diagram that illustrates an example of a screen display with useful categories for information that can be created for a business service 248, shown in FIG. 2, through an API framework module 402, relating to claims filing and comprising the following categories and sub-categories:
Claims filing and response 512, shown in FIG. 4;
   Claims submission 513;
   Claims status 514;
   Claims correction 515; and
Eligibility and benefits 516. For example, monitoring regarding claims filing might be conducted to determine the number of claims submissions that had to be corrected week by week.

The API framework module 402, shown in FIG. 2, can also be used to specify how often monitored data should be updated, for example every fifteen minutes or every day.

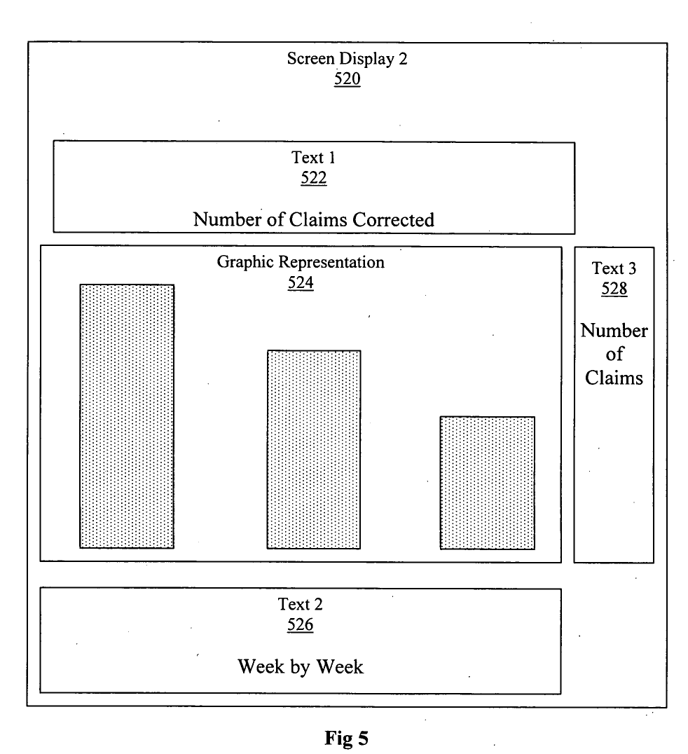

FIG. 5 is block diagram that illustrates an example of how the API-framework-module metadata for the presentation of monitoring information can be used for a screen display with useful text and graphic elements. Text messages 522, 526, and 528 identify the information, and a graphic representation 524 illustrates that information.

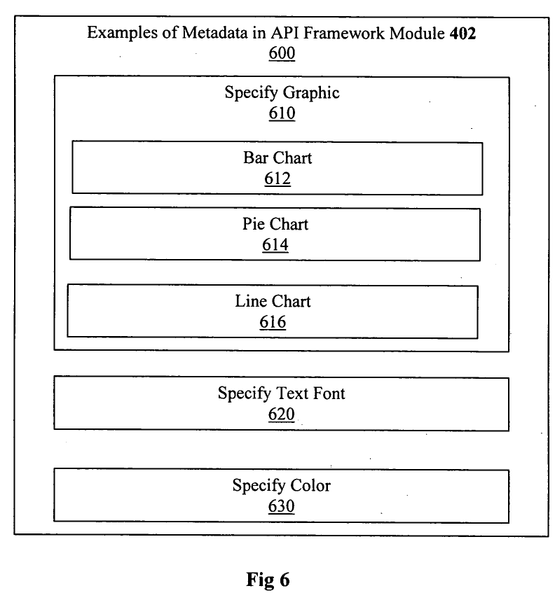

FIG. 6 is block diagram that illustrates an example of useful metadata 600 that might be made available through an API framework module 402, shown in FIG. 2, comprising monitoring presentation options that would allow the programmer of a business service to
Specify the graphics 610, shown in FIG. 6, to be used, such as a bar chart 612, pie chart 614, or line chart 616;
Specify the text font 620; and
Specify the colors 630 of different elements in the display.
   Creating the Monitoring Utility

To return to FIG. 3, after the API framework module 402 has been created, the next step 2000 is for a programmer to employ the data in the API framework module 402, shown in FIG. 2, to create a corresponding monitoring utility 400. The monitoring utility 400 can be used to query a business service 248 into which an API framework module 402 has been incorporated and to display the monitored information on a display 1414.

The monitoring utility 400 communicates with business service 248 over a wired or wireless link 302, a local network 300, and another wired or wireless link 308.

Setting Up a Business Service

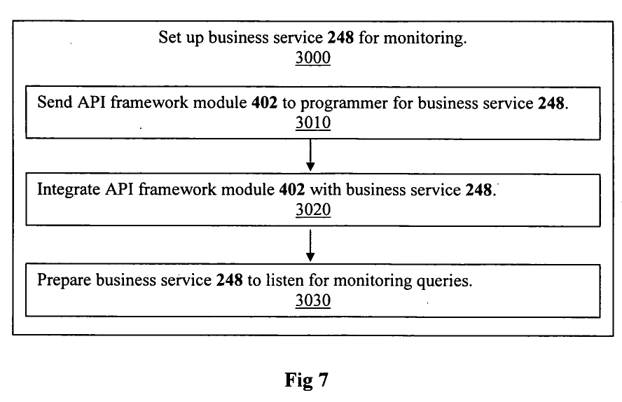

Returning to FIG. 3, the next step 3000 in the monitoring process is to set up a business service 248, shown in FIG. 2, for monitoring. FIG. 7 is a flow chart that illustrates the process of setting up a business service 248, shown in FIG. 2, for monitoring.

Step 3010 in FIG. 7. Send API framework module 402 to a programmer for business service 248.

In an embodiment, the API framework module 402 is sent from business server 100 over link 302, network 2 300, and link 308 to a programmer at server 4 186. For example, it could be sent as an e-mail attachment. Many other methods of delivery are possible in other embodiments.

Step 3020 in FIG. 7. Integrate API framework module 402 with business service 248.

In an embodiment, a programmer at server 4 186, shown in FIG. 2, writes plug-in code 404 to incorporate API framework module 402 into business service 248 to predetermine the categories of information to be monitored, the way that information will be presented in a screen display, and the time interval for updates.

Step 3030 in FIG. 7. Prepare business service 248, shown in FIG. 2, to listen for monitoring queries.

In an embodiment, a programmer at server 4 186 sets up business service 248 to listen and respond to queries sent to it over local network 300.

Conducting Monitoring

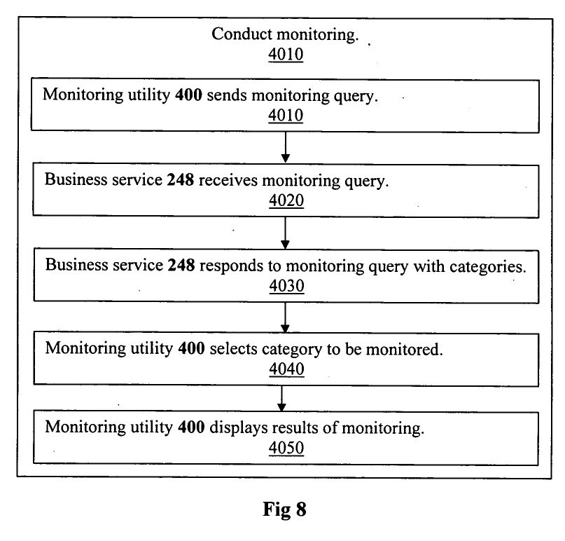

Returning again to FIG. 3, the next step 4000 in the monitoring process is to conduct the monitoring. FIG. 8 is a flow chart that illustrates the process of conducting monitoring.

Step 4010 in FIG. 8. Monitoring utility 400 sends monitoring query.

In an embodiment, monitoring utility 400, shown in FIG. 2, sends a monitoring query to business service application 1 240, which relays the query to business service 1 242 and over link 302, to network 2 300. Network 2 300 relays the query to all other member servers 182, 184, 186, and 188, over links 304, 306, 308, and 310. In this way the query reaches all the business services 242, 244, 246, 248, and 250 connected through business service application 1 240.

For example, the query could be about the number of claims requiring corrections.

In another embodiment, monitoring utility 400 sends the monitoring query to over link 302 to network 2 300. Network 2 300 relays the query to all other member servers 100, 182, 184, 186, and 188, over links 302, 304, 306, 308, and 310, so that the query reaches all the business services 241, 242, 244, 246, 248, and 250.

In other embodiment, still other methods of routing the query are possible.

Step 4020 in FIG. 8. Business service 248 receives monitoring query.

The business specific service preconfigured to answer the query receives the query. To follow the current example, business service 248 is the business service preconfigured to answer queries about claims corrections.

Step 4030 in FIG. 8. Business service 248 responds to monitoring query with categories.

In an embodiment, business service 248, shown in FIG. 2, employs its preconfigured API framework module 402 to display the categories of information business service 248 can monitor. For example, it might present the screen display in FIG. 4, showing categories associated with claims filing.

Step 4040 in FIG. 8. Monitoring utility 400 selects category to be monitored.

In an embodiment, an operator at monitoring utility 400, shown in FIG. 2, selects the category to be monitored. For example the operator might select the claims correction 515 category shown in FIG. 4.

Step 4050 in FIG. 8. Monitoring utility 400 displays results of monitoring.

In an embodiment, the business service 248, shown in FIG. 2, employs its preconfigured API framework module 402 to send a screen display of the monitored information for category 515, shown in FIG. 4, back to server 100, shown in FIG. 2. Monitoring utility 400 then shows the screen display on display 1414. For example, the screen display shown in FIG. 5 might appear.

Updating Monitoring

In the final step 5000 in the monitoring process of FIG. 3, in an embodiment the business service 248, shown in FIG. 2, employs its preconfigured API framework module 402 to send update information about the monitored category at the preconfigured time interval. For example, business service 248 might send an update of the information every fifteen minutes, for display on display 1414.

Computer System Overview

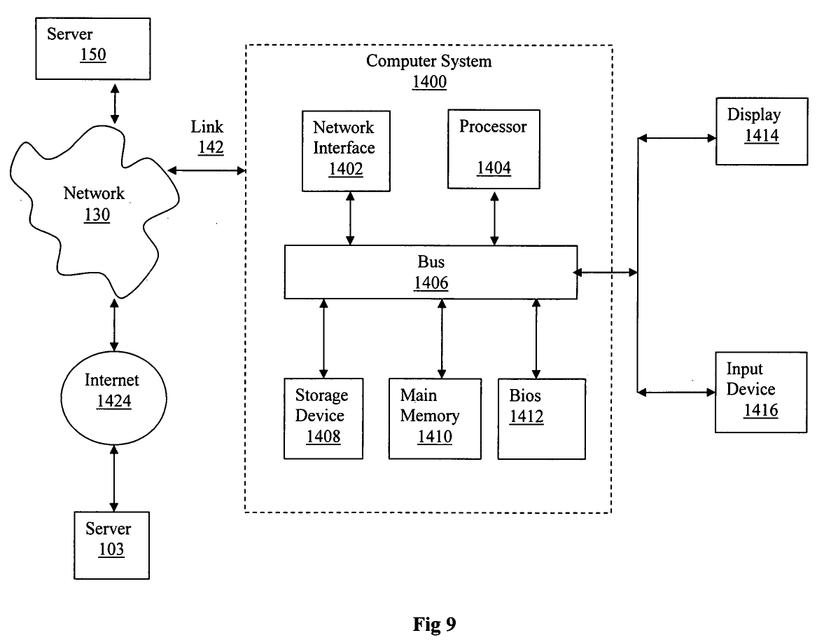

FIG. 9 is a block diagram that illustrates an example of a typical computer system 1400, well known to those skilled in the art, representing server 100, shown in FIG. 2, on which embodiments of the present invention can be implemented. This computer system 1400 in FIG. 9 comprises a network interface 1402 that provides two-way communications through a wired or wireless link 142 to a wired or wireless communications network 130 that uses any applicable communications technology. For example, the network 130 can comprise a public telephone network, a wireless network, a local area network (LAN), and any known or not-yet-know applicable communications technologies, using correspondingly applicable links. The network 130 in turn provides communications with one or more host computers 150 and, through the Internet 1424, with one or more servers 103.

The network interface 1402 is attached to a bus 1406 or other means of communicating information. Also attached to the bus 1406 are the following:
a processor 1404 for processing information;
a storage device 1408, such as an optical disc, a magneto-optical disc, or a magnet disc, for storing information and instructions;
main memory 1410, which is a dynamic storage device such as a random access memory (RAM) that stores information and instructions to be carried out by processor 1404;
a bios 1412 or another form of static memory such as read only memory (ROM), for storing static information and instructions to be carried out by processor 1404;
a display 1414, such as a liquid crystal display (LCD) or cathode ray tube (CRT) for displaying information to user of the computer system 1400; and
an input device 1416, with numeric and alphanumeric keys for communicating information and commands to processor 1404. In another embodiment a mouse or other input devices can also be used.

The computer system 1400 is used to implement the methods of the present invention in one embodiment. However, embodiments of the present invention are not limited to specific software and hardware configurations. Computer system 1400 can receive data comprising client application messages from computer 150 and server 103 used by client business, through a network 130 such as the Internet, an appropriate links 142, such as wired or wireless ones, and its network interface 1402. It can of course transmit data back to client business application over the same routes.

Computer system 1400 carries out the methods of the present invention when its processor 1404 processes instructions contained in its main memory 1410. Another computer-readable medium, such as its storage device 1408, may read these instructions into main memory 1410 and may do so after receiving these instructions through network interface 1402. Processor 1404 further processes data according to instructions contained in its storage device 1408. Data is relayed to appropriate elements in computer system 1400 through its bus 1406. Instructions for computer system 1400 can also be given through its input device 1416 and display 1414.

“Computer-readable medium” refers to any medium that provides instructions to processor 1404, comprising volatile, non-volatile, and transmission media. Volatile media comprise dynamic memory, such as main memory 1410. Non-volatile media comprise magnetic, magneto-optical, and optical discs, such as storage device 1408. Transmission media comprise a wide range of wired and unwired transmission technology, comprising cables, wires, modems, fiber optics, acoustic waves, such as radio waves, for example, and light waves, such as infrared, for example. Typical examples of widely used computer-readable media are floppy discs, hard discs, magnetic tape, CD-ROMs, punch cards, RAM, EPROMs, FLASH-EPOMs, memory cards, chips, and cartridges, modem transmissions over telephone lines, and infrared waves. Multiple computer-readable may be used, known and not yet known, can be used, individually and in combinations, in different embodiments of the present invention.

### Alternate Embodiments

It will also be apparent to those skilled in the art that different embodiments of the present invention may employ a wide range of possible hardware and of software techniques. For example the communication between servers could take place through any number of links, including wired, wireless, infrared, or radio ones, and through other communication networks beside those cited, including any not yet in existence.

Also, the term computer is used here in its broadest sense to include personal computers, laptops, telephones with computer capabilities, personal data assistants (PDAs) and servers, and it should be recognized that it could include multiple servers, with storage and software functions divided among the servers. A wide array of operating systems, compatible e-mail services, Web browsers and other communications systems can be used to transmit messages among client applications and Web services.

Furthermore, in the previous description the order of processes, their numbered sequences, and their labels are presented for clarity of illustration and not as limitations on the present invention.

Example of Plug-in Code for Setting Up a Business Service for Monitoring

This section presents representative examples of plug-in code 404 used in the API framework module 402, shown in FIG. 2, to set up a business service 250 for monitoring in an embodiment, as shown in Step 3000 in FIG. 3.

This plug-in code 404 tells the monitoring utility 400, shown in FIG. 2, how to conduct monitoring, as shown in Step 4000 in FIG. 3 and how to periodically update the monitoring, as shown in Step 5000.

The plug-in code 404 needs to describe to the monitoring utility 400 the types of graphs required to monitor this resource. To do this, the plug-in code 404 provides a method, getDataDescriptors( ), which returns objects which describe the graph to be shown in the monitoring utility 400. In this case, a bar graph is described that tracks the number of claims corrected each day.

public BaseData[ ] getDataDescriptors( ) {

BaseData[ ] descriptors = new BaseData[1];
BarGraphData resourceGraph = new BarGraphData( );
resourceGraph.setTitle(“Claims Corrected by Day”);
resourceGraph.setAxisXLabel (“Day”);
resourceGraph.setAxisYLabel (“Number of Claims”);
resourceGraph.setMethodName (“getCorrectedClaimCount”);

The following code is used to tell the API framework 402, shown in FIG. 2, how often to call the plug-in code 404 to get the latest number of corrected claims:

// once per day, in seconds
resourceGraph.setPollFrequency(60*60*24);

The following code is used to specify the number of polls that the API framework 402 should remember (this cooresponds to the number of bars in the graph):

resourceGraph.setHistoryCount(7); // keep 7 days history

descriptors[0] = resourceGraph;
return descriptors;

}

The plug-in code 404 would also provide a method to actually return the number to a graph. In the example above, this method is called “getCorrectedClaimCount”:
public float getCorrectedClaimCount(int day) {return 10;}

This method could make a database query, or use other means, to determine the number to return.

Configuration of the plug-in code 404 so it can be located by the API framework 402 is done through JMX (Java Management Extensions). The plug-in code 404 is listed as a JMX resource as follows:

```
<resource
  mbean-name=“webify:type=BusinessResourceMBean,name=XEngine”
  type=“com.webify.hta.XEngineMonitor”/>
```

After starting up, the monitoring utility 400 uses JMX to contact the API framework module 402 to locate all plug-in codes 404 available on that system. The monitoring utility 400 can then contact each plug-in code 404 in turn to create the graphs and charts to display.

What is claimed is:

1. An automated method for monitoring the activities of business services and displaying graphic representations of the monitoring, the method comprising the computer-implemented steps of
creating an application program interface (“API”) framework module;
creating a monitoring utility;
setting up a business service in a business service application for monitoring;
conducting monitoring of the business service; and
updating the monitoring of the business service periodically.

2. The method of claim 1 wherein creating the API framework module further comprises
creating the API framework module to enable monitoring of business services, and
updating the monitoring of business services.

3. The method of claim 1 wherein creating the API framework module further comprises
creating the API framework module to provide a framework for the business service to respond to monitoring queries according to parameters set up for the business service, those parameters comprising
useful categories of information to be monitored, and
metadata for the presentation of those categories of information.

4. The method of claim 1 wherein creating the monitoring utility further comprises
using the API framework module to create the monitoring utility, the monitoring utility enabling
monitoring business services into which the API framework module has been incorporated, and
generating graphic representations of that monitoring.

5. The method of claim 1 wherein setting up the business service for monitoring further comprises
transferring the API framework module to the business service;
creating plug-in code to integrate the API framework module into the business service;
using the plug-in code to integrate the API framework module into the business service; and
preparing the business service to listen for monitoring queries.

6. The method of claim 5 wherein creating plug-in code to integrate the API framework module into the business service further comprises configuring the plug-in code to predetermine
the categories of information to be monitored at the business service;
the way that monitored information will be presented in a screen display by the monitoring utility; and
the time interval at which the monitored information will be updated.

7. The method of claim 5 wherein preparing the business service to listen for monitoring queries comprises
setting up the business service to
listen to queries sent to the business service over a network, and
to respond to those queries.

8. The method of claim 1 wherein conducting monitoring of the business service further comprises
sending a monitoring query from the monitoring utility to the business service;
receiving the monitoring query at the business service;
employing the API framework module to display the predetermined categories the business service can monitor;
selecting the category to be monitored at the business service; and
displaying by the monitoring utility the results of the monitoring.

9. The method of claim 5 wherein updating monitoring of the business service periodically further comprises
employing the API framework module incorporated into the business service to send to the monitoring utility for display update information about at least one monitored category at a preconfigured time interval specified by the plug-in code.

10. An automated method for monitoring the activities of business services and displaying graphic representations of the monitoring, the method comprising the computer-implemented steps of
creating an API framework module on a source server;
creating a monitoring utility on the source server;
setting up for monitoring a business service on a second server, the business service being linked to a business service application on the source server;
conducting monitoring of the business service; and
updating the monitoring of the business service periodically.

11. The method of claim 10 wherein setting up for monitoring a business service on a second server, the business service being linked to a business service application on the source server further comprises
transferring the API module to the business service;
creating plug-in code to integrate the API framework module, into the business service,
such that configuring the plug-in code predetermines
the categories of information to be monitored at the business service,
the way that monitored information will be presented in a screen display by the monitoring utility, and
the time interval at which the monitored information will be updated.

12. An automated method for monitoring the activities of business services and displaying graphic representations of the monitoring, the method comprising the computer-implemented steps of
creating an API framework module, such that the API framework module enables monitoring of business services,
enables updating the monitoring of business services, and
provides a framework for a business service to respond to monitoring queries according to parameters set up for the business service, those parameters comprising
useful categories of information to be monitored, and
metadata for the presentation of those categories of information;
creating a monitoring utility, such that
the monitoring utility uses the API framework module to
monitor business services into which the API framework module has been incorporated, and
generate graphic representations of that monitoring;
setting up the business service in a business service application for monitoring, such that setting up the business service comprises
transferring the API module to the business service,
creating plug-in code to integrate the API framework module, into the business service, such that
configuring the plug-in code predetermines
the categories of information to be monitored at the business service,
the way that monitored information will be presented in a screen display by the monitoring utility, and
the time interval at which the monitored information will be updated;
using the plug-in code to integrate the API framework module into the business service, and
preparing the business service to listen for monitoring queries;
conducting monitoring of the business service, such that conducting the monitoring comprises
sending a monitoring query from the monitoring utility to the business service,
receiving the monitoring query at the business service,
employing the API framework module to display the predetermined categories that the business service can monitor,
selecting the category to be monitored at the business service, and
displaying by the monitoring utility the results of the monitoring; and
updating the monitoring of the business service periodically, such that the updating comprises
employing the API framework module incorporated into the business service to send to the monitoring utility for display update information about at least one monitored category at the preconfigured time interval specified by the plug-in code.

13. A system for monitoring the activities of business services and displaying graphic representations of the monitoring, the system comprising
a first server;
an API framework;
a monitoring utility;
at least one second server;
a business service on the second server; and
plug-in code on the second server.

14. The system of claim 13 wherein
the API framework is provided on the first server;
the API framework is transferred to a second server; and
the API framework is incorporated into the business service on the second server by plug-in code created on the second server.
